(19) United States
(12) Patent Application Publication
(10) Pub. No.: US 2009/0019386 A1
(43) Pub. Date: Jan. 15, 2009

(54) Extraction and reapplication of design information to existing websites

(75) Inventors: Reilly Sweetland, Los Gatos, CA (US); Matthew Rosetta, San Jose, CA (US); Ian Silber, San Jose, CA (US); Jeff Corner, San Jose, CA (US); Joren Mathews, San Jose, CA (US)

Correspondence Address: HAVERSTOCK & OWENS LLP, 162 N WOLFE ROAD, SUNNYVALE, CA, 94086, US

(73) Assignee: Internet Simplicity, a California corporation

(21) Appl. No.: 12/218,181

(22) Filed: Jul. 10, 2008

Related U.S. Application Data
(60) Provisional application No. 60/959,546, filed on Jul. 13, 2007.

(51) Int. Cl. G06F 3/048

(52) U.S. Cl. 715/765

(57) ABSTRACT

A method and system is provided that allows for the extraction of design templates and other design information from an existing website through a visual point-and-click interface, requiring no programming knowledge; the detection and application of these templates across a plurality of existing web pages; as well as the application of these templates to newly generated content and newly generated or existing software.

### CROSS-REFERENCE TO RELATED APPLICATIONS

This application claims the benefit of U.S. Provisional Patent Application Ser. No. 60/959,546, filed Jul. 13, 2007 and entitled CONTENT MANAGEMENT SYSTEM INNOVATIONS; which is hereby incorporated herein by reference in its entirety for all purposes.

### FIELD OF THE INVENTION

The present invention relates to the field of website generation, maintenance and, more specifically, to web content management systems.

### BACKGROUND OF THE INVENTION

The majority of websites currently online use a pattern where a limited number of unique designs and page layouts are applied to a multitude of web pages containing different content. The containing text and photos of a page are able to be unique, yet the page shares a theme and template with other pages of the website.

Separating the content from the design has many advantages, and many web content management systems (hereafter abbreviated, “CMS”) today make use of this separation with the use of templates that are built to work for each specific CMS.

The problems start to arise with the way that existing templating systems are implemented in a CMS. The following shortcomings currently exist:
The person developing the templates requires programming knowledge.
The template developer typically requires special, proprietary knowledge of the particular CMS they are using.
Migrating an existing page onto a newly generated template is a laborious copy and paste process that also requires programming knowledge.
The design templates that exist in the CMS are able to only be applied to pages that are in the CMS, not to external applications.

As website owners continue to upgrade their websites to take advantage of superior technology on new platforms, the process of having to re-apply their design template over and over in a proprietary CMS format each time becomes more and more cumbersome.

### SUMMARY OF THE INVENTION

A method and system is provided that allows for the extraction of design templates and other design information from an existing website through a visual point-and-click interface, requiring no programming knowledge; the detection and application of these templates across a plurality of existing web pages; as well as the application of these templates to newly generated content and newly generated or existing software.

One aspect of the present invention is a point-and-click system to enable a user to generate a transferable design from an existing website or HTML page, thereby allowing non-technical users to generate templates and portable designs that are able to be used across new systems.

Another aspect of the invention is to provide a visual interface for the re-application of the generated templates to pre-existing (X)HTML files, thereby generating a separation between the design information and the data contained in the website.

Another aspect of the invention is a method and system to facilitate use of the designs obtained in the first paragraph above with new CMSs and applications such as blogs, community forums, polls and similar applications.

In another aspect, a computer-implemented method of extracting a design template from a document comprises presenting a rendered page on a first interface to a viewer, enabling the viewer to visually select elements from the rendered page using an interactive element, enabling the viewer to specify how the selected elements relate to one or more template-regions of the design template using a second interface and replacing the selected elements with programming code as dictated by the design template. The rendered page is a rendered HTML page and the elements are HTML elements. The method is performed as a web service wherein a web server is configured to host a program performing the method and the web service is configured to obtain html by performing an http or https request to a second web server and a user interface of the program is a website. User information is associated with the design template. The interactive element is generated by drawing a visual queue around or on top of the selected element upon hovering over the selected element, and upon clicking, a visual indication of the selected element is persisted. The method further comprises generating an iconic representation of the design template as the viewer selects the template-regions of the design template by recording physical dimensions of the selected template-regions, recording total dimensions of the page and using the physical dimensions and the total dimensions to dynamically generate the iconic representation in proportion to the design template. The iconic representation of the design template takes the form of the rendered design template with graphical overlays to illustrate the template's regions. Each template-region of the template-regions are visually differentiated in at least one of color, texture and animation based on a type of the template-region selected. The design template and the template-regions are pre-specified with preferential criteria for the elements required which guide actions of the interactive element to suggest or prevent selections of the elements. The design template utilizes a generic template definition which is defined using at least one of the criteria: types of the template-regions required by the design template, a number of the template-regions required of a certain type, which of the elements act as a container for a template-region of the template regions, which of the elements are contained in the template-region, preferred elements for the template-region, an explicit programming notation existing that indicates that a certain area in the page corresponds with a template-region definition and a model content for each of the template-regions for comparison. The elements are automatically selected based on matching at least one of the criteria. A selectable element includes a first repeated listing of similar elements that correspond with a second repeated listing of template-regions which are selected as a single aggregate template region. The method further comprises proactively asking the viewer to select a specific template-region of the template in a sequential fashion. The viewer proactively selects which type of the template-region corresponds with the element the viewer is selecting.

In yet another aspect, a computer-implemented method of extracting Cascading Style Sheet (CSS) style information out of an existing page comprises presenting a rendered page on a first interface to a viewer, enabling the viewer to visually select elements from the rendered page using an interactive element, enabling the viewer to specify how the selected elements relate to one or more template-regions of a design template using a second interface, replacing the selected elements with programming code as dictated by the design template, storing previous contents of a selected template region of the one or more template-regions, extracting the CSS style information from the selected elements, storing the CSS style information applied to each selected element of a certain type in a template-region of the one or more template-regions and sorting the type of the template-region that contains the CSS style information obtained. The rendered page is a rendered HTML page and the elements are HTML elements. The CSS style information is distilled by finding a most common group of styles that are applied to a same type of element at a same time most frequently. The CSS style information from a specified type of the template-region is stored, while the CSS style information not from the specified type of the template-region is not stored. The CSS style information is collected for a parent element of the element to determine inherited styles.

In another aspect, a computer-implemented method of storing and retrieving design information comprises a repository of style information collected by presenting a rendered page on a first interface to a viewer, enabling the viewer to visually select elements from the rendered page using an interactive element, enabling the viewer to specify how the selected elements relate to one or more template-regions of a design template using a second interface, replacing the selected elements with programming code as dictated by the design template, storing previous contents of a selected template region of the one or more template-regions, extracting the Cascading Style Sheet (CSS) style information from the selected elements, storing the CSS style information applied to each selected element of a certain type in a template-region of the one or more template-regions and sorting the type of the template-region that contains the CSS style information obtained, wherein the style information is programmatically accessible through an application programming interface. The rendered page is a rendered HTML page and the elements are HTML elements.

In another aspect, a computer-implemented method where an external application pulls essential design information as obtained by presenting a rendered page on a first interface to a viewer, enabling the viewer to visually select elements from the rendered page using an interactive element, enabling the viewer to specify how the selected elements relate to one or more template-regions of a design template using a second interface, replacing the selected elements with programming code as dictated by the design template, storing previous contents of a selected template region of the one or more template-regions, extracting the Cascading Style Sheet (CSS) style information from the selected elements, storing the CSS style information applied to each selected element of a certain type in a template-region of the one or more template-regions and sorting the type of the template-region that contains the CSS style information obtained, thereby pulling the template and essential design information from a remote source. The rendered page is a rendered HTML page and the elements are HTML elements.

In another aspect, a computer-implemented method of manually merging an existing web page into a specific design template comprises presenting a rendered page to a viewer, asking the viewer to choose a design template the page is merged into, enabling the viewer to visually select elements using an interactive element, enabling the viewer to specify how the selected element relates to a template-region of the design template using an interface, storing contents of the selected elements cross-referenced with the template-region each belongs to, a name of the page and a selected template. The rendered page is a rendered HTML page and the elements are HTML elements. The method further comprises presenting the viewer with the visual icon of the template, visually highlighting a specific template-region on the icon and requesting the viewer to choose the element on the page that corresponds with a visually highlighted element of the icon.

In another aspect, a computer-implemented method of automatically merging an existing web page into a specific design template comprises acquiring a document, comparing the document with a plurality of templates to determine a closest match by detecting a presence of common XPaths in each, identifying corresponding template-regions appearing in the document with the template-regions of a general design template as determined by corresponding XPath information, and template-definition criteria and storing contents of the selected elements cross-referenced with the template-regions each element contents belongs to, a name of the page and a selected template the page belongs to. The document is an HTML document and the plurality of templates are a plurality of HTML templates. The method switches to a manual merge when a failure to determine likeness to an existing template prompts the viewer with a request to perform one of manually selecting a matching template and generating a new template.

In another aspect, a computer-implemented system for extracting a design template from a document comprises a first interface configured for presenting a rendered page to a viewer, an interactive element operatively coupled to the first interface, the interactive element configured for enabling the viewer to visually select elements from the rendered page, a second interface operatively coupled to the interactive element, the second interface configured for enabling the viewer to specify how the selected elements relate to one or more template-regions of a design template and a display for presenting replacement of the selected elements with programming code as dictated by the design template. The rendered page is a rendered HTML page and the elements are HTML elements. The computer implemented system is selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPod®, a video player, a DVD writer/player, a television and a home entertainment system.

In yet another aspect, an apparatus comprises a memory for storing an application, the application configured for storing and retrieving design information comprising a repository of style information collected by presenting a rendered page on a first interface to a viewer, enabling the viewer to visually select elements from the rendered page using an interactive element, enabling the viewer to specify how the selected elements relate to one or more template-regions of a design template using a second interface, replacing the selected elements with programming code as dictated by the design template, storing previous contents of a selected template region of the one or more template-regions, extracting the Cascading Style Sheet (CSS) style information from the selected elements, storing the CSS style information applied to each selected element of a certain type in a template-region of the one or more template-regions and sorting the type of the template-region that contains the CSS style information obtained, wherein the style information is programmatically accessible through an application programming interface and a processing component coupled to the memory, the processing component configured for processing the application. The rendered page is a rendered HTML page and the elements are HTML elements. The apparatus is selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPod®, a video player, a DVD writer/player, a television and a home entertainment system.

### BRIEF DESCRIPTION OF THE DRAWINGS

FIG. 1 is a depiction of the main elements discussed: a template, template-regions and a web page.

FIG. 2 is a high level diagram showing the arrangement of the Service and its primary functions and relationship with other entities.

FIG. 3 is an exemplary template definition that is used to generate a design template.

FIG. 4 is a diagram showing how certain sections of an HTML document are made selectable as well as an embodiment of the interactive element for selecting portions of the HTML document.

FIG. 5 is a diagram showing the generation of an iconic representation of the design template generated in the template generation process.

FIG. 6 is a depiction of how the HTML document is transformed into a template through the use of the user input obtained in the previous steps.

FIG. 7 is a diagram showing the method of extraction of generalized CSS style information about the templates.

FIG. 8 is an illustration showing an example of how the template and design information interact with a remote web service.

FIG. 9 is an illustration showing an embodiment of the process of merging an existing website page into an existing template.

FIG. 10 is a depiction of the process of automated merging of documents into one of a plurality of templates.

FIG. 11 illustrates a block diagram of an exemplary computing device configured to implement the method of extracting and reapplying design information to existing websites.

### DETAILED DESCRIPTION OF THE PREFERRED EMBODIMENT

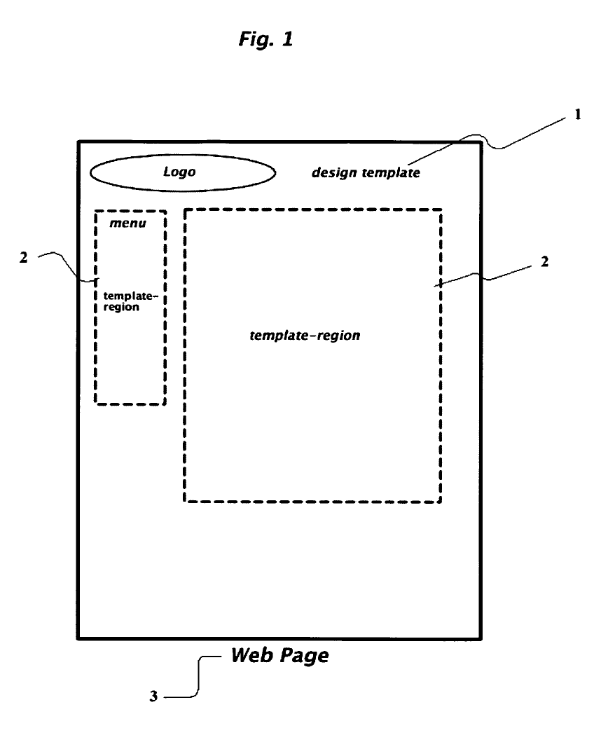

FIG. 1 illustrates the main elements discussed: a template, template-regions and a web page. A design template 1 (also referred to as a template) is the surrounding design that is used as a static container and overarching theme for website pages. One template is able to be used on many pages and is able to contain many template-regions. A template-region 2 is the place in the template 1 where dynamic information appears. While the template 1 remains constant, the template-region 2 is able to contain information that changes based on the page or other application function. A web page 3 is a single website page comprising the template 1 combined with specific dynamic content. An HTML document is used as a generalized form of a “web page” since a “web page” implies presence of the HTML on the Internet. An “HTML element” is a complete html element from opening tag to closing tag, as well as its contents. For example, the following is a paragraph HTML element: “<p>Paragraph text here</p>”. HTML elements are able to include other HTML elements as child nodes. “HTML” refers to both HTML and its successor XHTML.

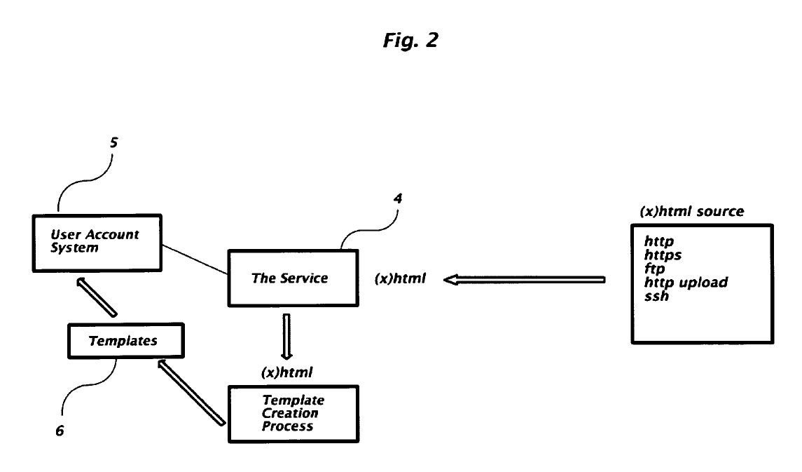

FIG. 2 illustrates a high level diagram showing the arrangement of the Service and its primary functions and relationship with other entities. The preferred embodiment of this invention is a hosted service 4 that interacts with other web servers using standard web protocols (e.g. http, https, ftp, sftp), or by directly uploading HTML to the service. (The hosted service 4 is hereafter referred to as “the Service” 4). The Service 4 is offered as a web application and also contains user accounts and logins in the user account system 5 for users to be able to access their design templates 1 (FIG. 1) and information through the Service 4. In some embodiments, the design templates 1 (FIG. 1) are stored in a template storage system 6.

One objective of the Service 4 is to take an existing HTML document and make the necessary modifications to turn the document into a design template that is able to be used by another web application.

Prior to beginning the conversion of a static HTML file to a template 1 (FIG. 1), a generic specification is able to be provided about the templates 1 (FIG. 1) and template-regions 2 (FIG. 1) including constraints and preferences on the template-regions 2 (FIG. 1) and the template 2 (FIG. 1).

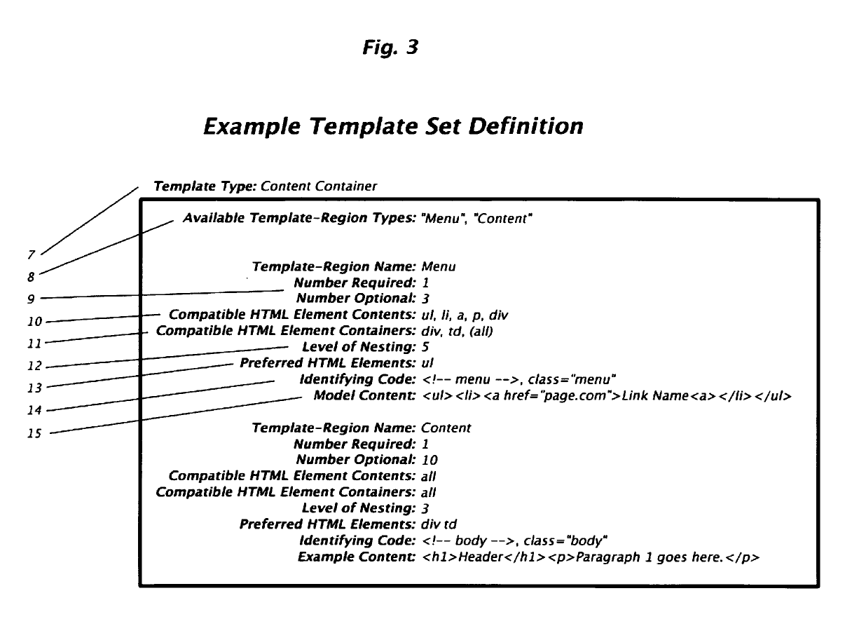

FIG. 3 is an example template definition that is used to generate a design template 1 (FIG. 1). The following generic criteria are able to be specified about the template-regions 2 (FIG. 1) of a set of design templates 1 (FIG. 1):
Types of templates 7 that are available (for example, content container, product listing)
Types of template-regions 8 that are available within a template (for example: Menu, Editable Content, News Listings)

Number of each template-region that is required or that is optional 9 (for example, a CMS support system that requires at least one, but that is able to optionally support up to 3 menus).
Compatible HTML element types that exist within template-regions 10 (for example, a specific CMS system only supports unordered lists for menus and therefore requires the complete selection of an unordered list and only an unordered list).
Compatible HTML element types that are able to act as containers 11 for certain template-regions (for example, a content area is able to be required to be located in a <div>).
Compatible HTML element's parent or child criteria 12 for certain template-regions (for example, a certain CMS content region that is not able to support complex nesting of HTML elements, or certain specific HTML elements).
In addition to certain HTML elements being selectable or un-selectable, certain HTML elements are able to be preferred 13 and given a special visual indication of preference or recommendation that the viewer clicks on one element or one out of a grouping of elements.
HTML sections are able to also be marked as preferred by annotating code comments or a code pattern 14 around that element, thereby forcing the service to choose that region and automatically moving to the next step.
Model content 15 for a specific template-region that is able to be used in string-comparison functions to determine degree of similarity (for example, through the use of existing fuzzy logic string comparison utilities) is also able to be included.

More or less criteria are able to be included in a template definition.

The preferred way the template definition is embodied is in a configuration file by the Service 4, but is also able to be specified through a user interface within the Service 4 itself that is able to be accessed by an end-user. In this fashion, new generic template definitions are able to be generated, and the design extraction process as described below is able to be tailored to a specific template's needs.

Once the design definition is in place, the Service 4 receives HTML as covered in the above paragraph (illustrated in FIG. 2).

At this point, the Service 4 has the HTML and loops through each HTML element in the page (using the Document Object Model). The Service 4 detects the presence of links and references that are specified using non-absolute paths and rewrites them so the page will correctly render to the end user even though the page will be presented on a separate domain (essentially acting as a proxy server).

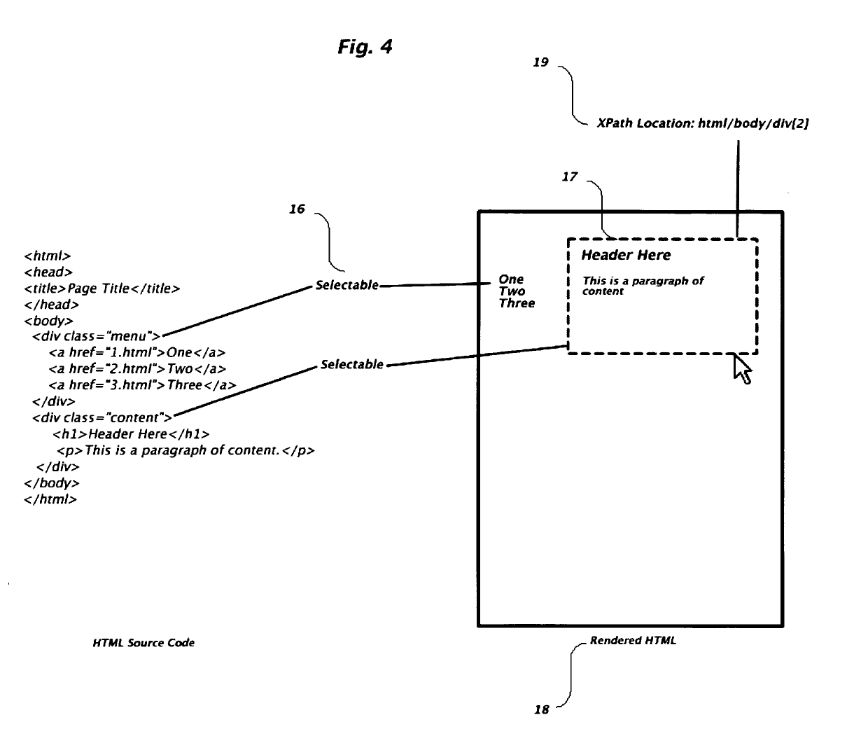

A visual point-and-click interface is then added to the web page through the use of JavaScript which allows a user to select certain elements on a page. FIG. 4 is a diagram showing how certain sections of an HTML document are made selectable as well as an embodiment of the interactive element for selecting portions of the HTML document. This is done in the following manner:
Looping through the HTML Document, certain HTML nodes are identified as “selectable” 16. The selection of the node is dependent upon the requirements of the template-region 2 (FIG. 1) that is needed as specified in the above paragraphs. (For example, if a CMS requires that an unordered list element (<ul>) is necessary for that particular CMS's menus, then only this element will be selectable. Certain items that have too many child HTML elements are able to not be considered selectable if they are too complex.)
Certain HTML elements will be further identified as “preferred” if they are annotated with special code comments, given a certain CSS class, or are of the type of element specified exactly by the generic template specification.
The identified nodes 17 are then given a special interactive attribute (preferably JavaScript “onMouseOver” event) so that when a viewer places their mouse over that specific node, the node will be highlighted. (A preferred way of highlighting is by drawing 4 colored divs (division tags) around each side of the selectable element upon a viewer hovering their mouse over, thereby drawing a box around the element).
The preferred HTML elements are able to be pre-selected in a visible form by, for example, drawing a more subtle box around that element.
The preferred HTML elements for that template-region are also able to be automatically selected and are able to or not automatically advance the user to the next step.

The page is rendered to the viewer with the above interactive functionality and the viewer is asked to click on which section of that page corresponds with a necessary template-region 18 (for example, a region of editable content).

The viewer identifies a section of the HTML document by clicking on one of the selectable regions 17.

The location of that selected element is saved in the form of an XPath 19 so that it is able to be programmatically referenced again.

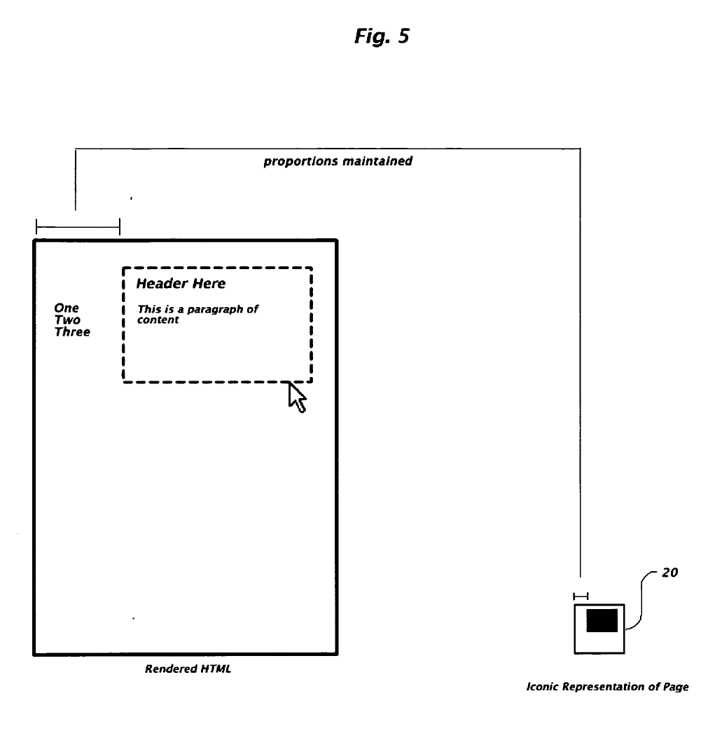

FIG. 5 is a diagram showing the generation of an iconic representation of the design template generated in the template generation process. The location of that selected element is also stored visually as a scaled down, iconic representation of the page 20 so it is able to be visually referenced again in human readable format.

This same pattern is repeated for multiple elements of the page so that multiple XPaths are stored which correspond with the different template-specific regions that are asked for, and multiple regions are visually generated on the icon. (The icon is able to show a specific region as having another color or other visual indicator that a template-region is of a certain type—for example: menu, editable content, news list and others).

When the necessary template-regions of a page are chosen, the page is then submitted to the server along with all the selected XPaths and the data for the visual iconic representation of the chosen elements.

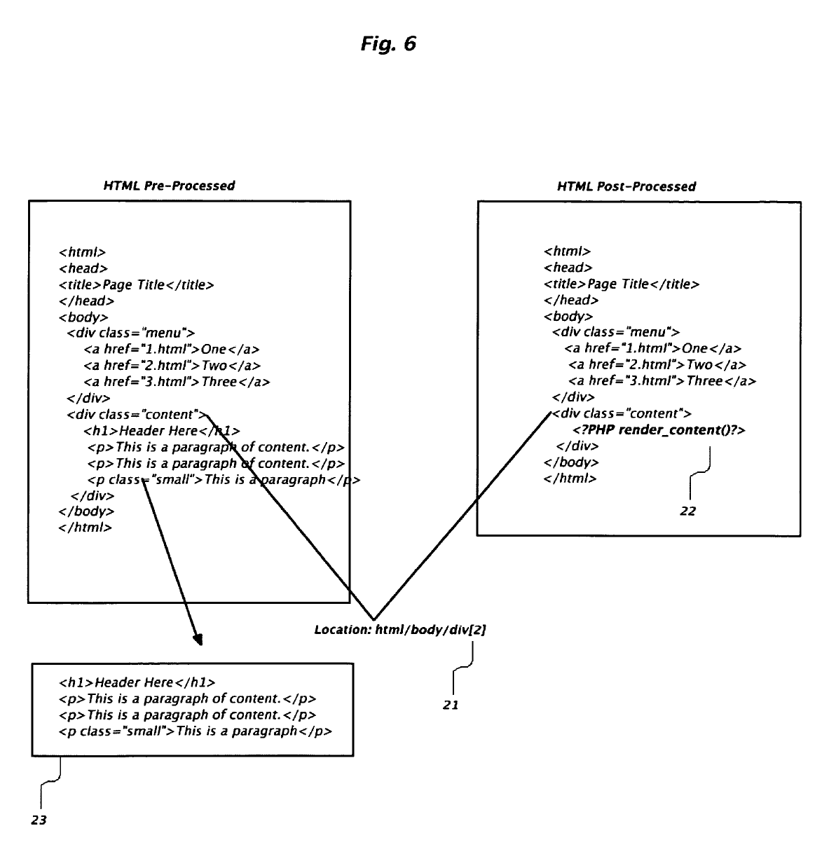

FIG. 6 is a depiction of how the HTML document is transformed into a template through the use of the user input obtained in the previous steps. The server takes this information, and uses the following technique to parse out the template information from the content information:
The server navigates to the proper node 21 (as identified in the XPath) and replaces the HTML content of this node with the appropriate template-specific code 22. (Note: that this is also able to be done on the client with JavaScript or in another utility). The original content 23 of the node (as identified by the XPath) is kept as a model example of the type of content that is able to be contained in that template-region.

As a result of the above steps, template regions are essentially “punched out” of a page, and in their place, the proper server-side code is inserted which is able to display dynamic content.

Prior to inserting the proper server-side code, the service is able to again read and interpret the previous contents of that template-specific node in order to fine-tune the exact correct server-side code to place in that region.

Further style information about the page is obtained in the following manner: As the viewer selects certain portions of the page in the above steps (for example, a main editable area of content), the Service 4 (FIG. 2) notes which element types appear in that template-specific region. For example, in a main content area, there will likely be many paragraph tags, as well as some heading tags.

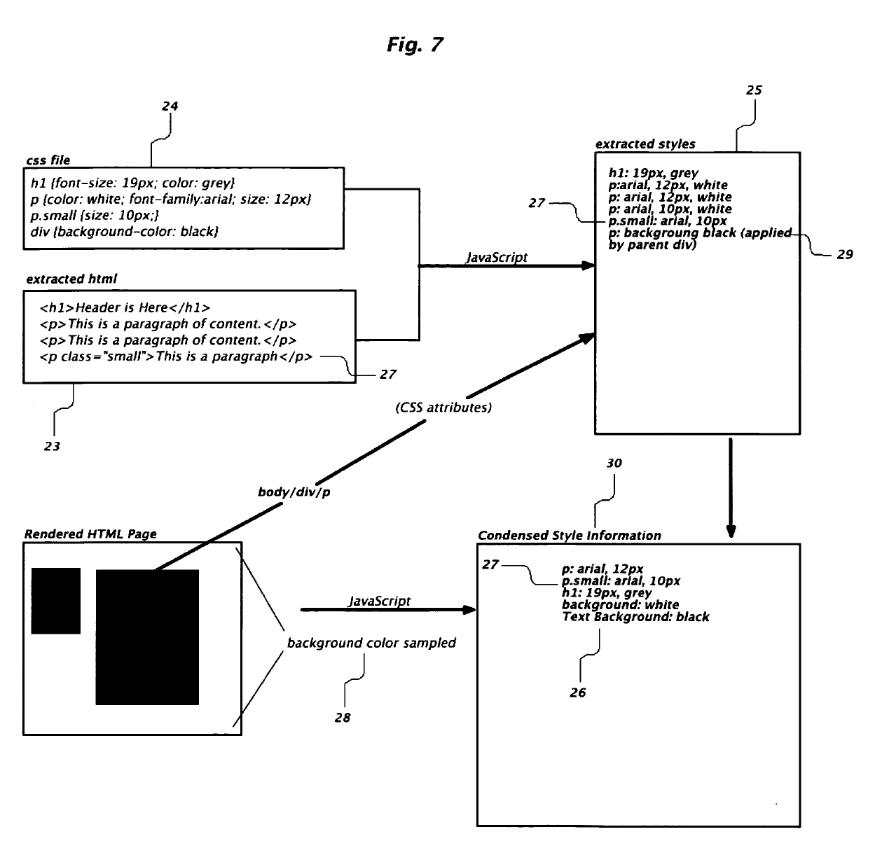

FIG. 7 is a diagram showing the method of extraction of generalized CSS style information about the templates. The rendered CSS display styles 24 for each of these elements are obtained through JavaScript. After style definitions are collected 25 for each element in the area, they are compared with one another to find the most common style definition for that element in that template-specific region. The most common style pattern is recorded as a general style element 26. Elements that have classes explicitly applied 27 to them have their style information associated with that class (so that a class definition is able to be acquired).

The Service 4 (FIG. 2) takes note of the coloration of the background 28 of the page by sampling the colors that appear on multiple edges of the screen. These are then used for the background color of the page.

The Service 4 (FIG. 2) is able to obtain additional style information for a given element by first pulling the styles applied directly to that element (with the available JavaScript functions that do this), then querying that element's parent, the parent's parent and so on, recursively up the HTML tree. In this fashion, data such as the background color of the text 29 (which is able to be different from the page background) is able to be determined (since background color is able to be specified by an HTML parent element nodes levels up).

In this fashion, the fundamental design information 30 for that page is extracted in addition to the normal website template as described above.

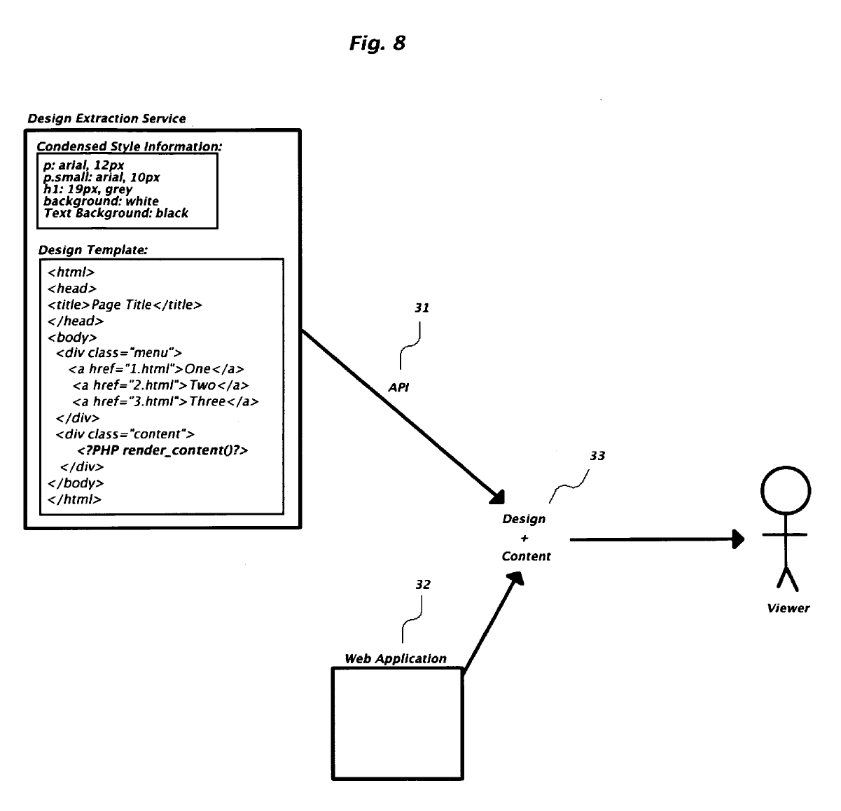

FIG. 8 is an illustration showing an example of how the template and design information interact with a remote web service. The Service 4 (FIG. 2) stores fundamental design information in a way that is programmatically accessible and consumable by another application, script or computer program.

At the simplest level, the Service 4 (FIG. 2) makes the basic design information (such as the text color, font information, header style information, and page background) available through the use of an Application Programming Interface (API) 31. An external application 32 is able to query the Service 4 (FIG. 2) to style itself “on the fly” 33 (or cache the information) and keep a consistent feel with the website that has already had the design information extracted from it by the Service 4 (FIG. 2).

Another application is in the case of the Service 4 (FIG. 2) passing the templates 1 (FIG. 1), the reference icons for the templates 1 (FIG. 1), and style definitions directly to another system (such as a CMS) that requires this information in order to operate.

Yet another application is the Service 4 (FIG. 2) integrating with a 3rd party application file while still located on the same computer as the Service 4 (FIG. 2), then publishing the 3rd party application complete with a pre-integrated template out to a remote server.

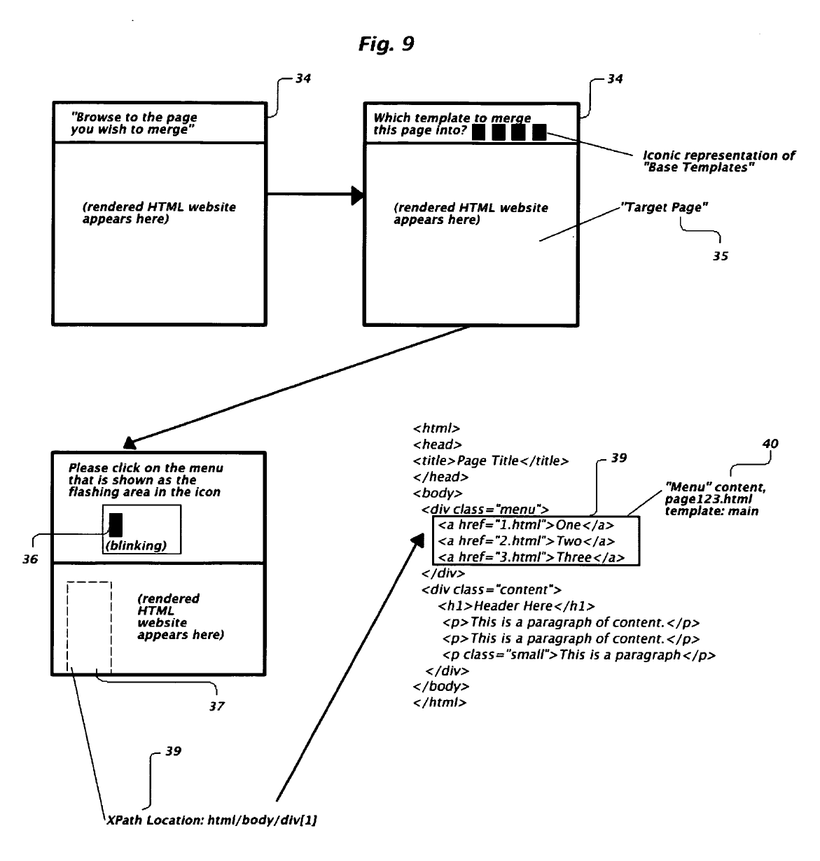

FIG. 9 is an illustration showing an embodiment of the process of merging an existing website page into an existing template. After a base set of templates and design information is extracted from a website, the Service 4 (FIG. 2) accounts for the scenario where additional website pages are merged into an existing template the Service 4 (FIG. 2) has generated (thereby achieving a separation of design information and content.)

For the purposes of this description, the term “base template” is used to describe the template that is generated using the process described in the above paragraphs. The term “target page” 35 is used to refer to a new page that does not yet make use of the base template for its design information. The target page is able to or not have similar design characteristics to the base template (for example, in the case of a website redesign), but will usually be a page that inherently is based off of that template, but that does not yet have the template separated from content at the code level.

To merge a target page into a base template, the following steps show one embodiment of this being accomplished. The preferred architecture is that of the “proxy server” arrangement described above:

The viewer is first asked to browse 34 to the page they wish to merge into a template. (They are able to also provide HTML directly using another fashion such as copy/paste, FTP upload, http upload, a bookmarklet or similar means). The page is then merged onto an existing template in one of two ways: manually or automatically.

### Manual Merging Method:

The viewer is asked to select the template that fits the particular page they wish to merge.

The viewer is then taken through a “visual guide” of choosing the corresponding editable regions of the template. This is done in the following fashion:

On the visual icon of the base template that has been chosen, one of the template-region begins to flash 36 (or provide some other visual indication) and the user is asked to identify in the target page the area which is flashing in the iconic representation of the base template. After the viewer clicks on this region 37 using the same selection mechanism as described above, and indicating to go to the next step (which is able to be just by the action of choosing) another region flashes and the viewer is asked to click on that section, and so on.

The request to click is able to not be prefaced by the application specifying the type of template-area on which to click. (For example, instead of the application specifying: “Please indicate the menu that is shown as the flashing area in the icon,” the user could first click on an area, then subsequently identify the corresponding template area)

The Service 4 (FIG. 2) acquires the XPath locations 39 to the content by the user clicking on the appropriate regions (as previously described), and the data is then sent to the server (in the preferred instance this step is also able to be accomplished on the client with JavaScript).

The Service 4 (FIG. 2) navigates to the XPaths that were selected in the target page. The content 40 is pulled out of each section and is able to or not be inserted into labeled storage areas that indicate what content appeared in which template-specific region.

Now that the Service 4 (FIG. 2) then has information on which template the target page is based off of and the corresponding value of each template-specific region for that template, the rest of the page elements are able to be discarded.

### Automated Merging Method:

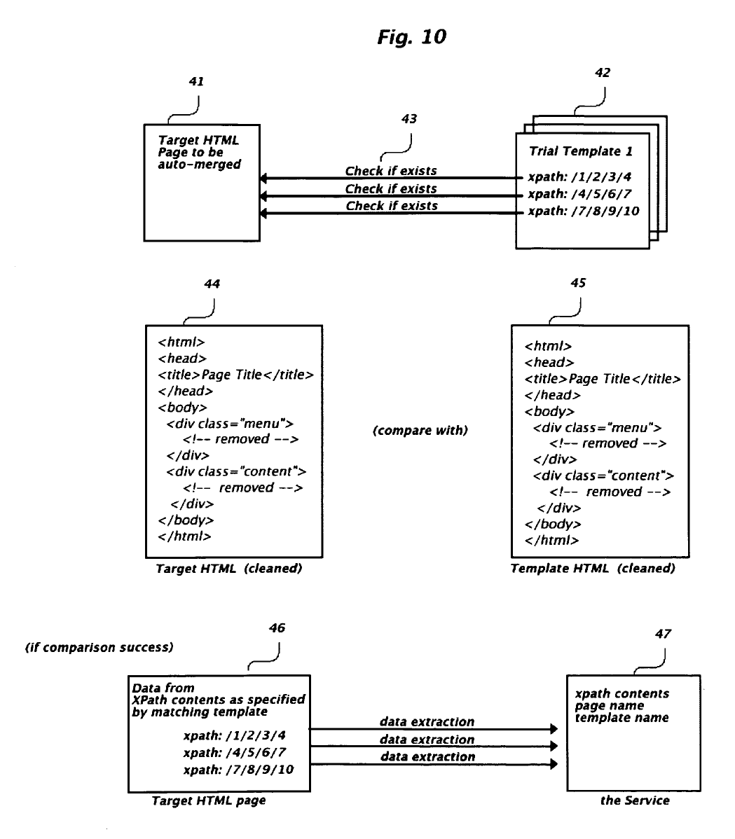

FIG. 10 is a depiction of the process of automated merging of documents into one of a plurality of templates. A user either browses to a page they wish to merge into the Service 4 (FIG. 2), or the Service 4 (FIG. 2) collects an aggregate grouping of the target site either by “spidering” (following links from page to page, downloading each one), accepting a bulk upload or other fashion to serve as an aggregate group of HTML documents.

The system takes a target page 41 one at a time, and performs an analysis on the page in order to detect what template the page belongs to. An embodiment of this is as follows:
1. The system chooses a trial template 42 to compare.
2. The system attempts to map the editable areas of the chosen template to see if those areas exist 43 in the selected page using the DOM and the XPath information described above.
3. If failing, the system chooses another template on which to perform this comparison.
4. When finding a match, the system removes these template-specific areas from the page, as well as any other hidden page-specific attributes such as meta tags.
5. The system also performs an HTML cleaning action 44 to strip unimportant elements from both pages (the template and the current page attempting to be matched). This includes whitespace, css and javascript code.
6. A comparison is then made against the chosen base template 45 (minus any template-region content) to see if the page being compared has the same template as the one that has thus far seemed to match.
7. If there is a match, it is recorded that this page does belong this specific template. If not, it chooses another template starting at number one above.
8. Assuming a match, it then records the values found in the content-regions, menus and meta tags as belonging to that page 46, and stores this, cross referenced with the page name, and what template 47 it belongs to.
9. In this way, a website page is identified as having a pre-existing template, and its template-specific content and attributes are stored separately.

This analysis is repeated for each page in a grouping of HTML pages, and a separation between content, and templates is achieved in this way.

If a page is found that does not match a pre-existing template, one is able to either generate a new template from that page, or merge that page's content into an existing template using the manual method as described above.

In this fashion, a user is able to achieve a separation of presentation and content from their website.

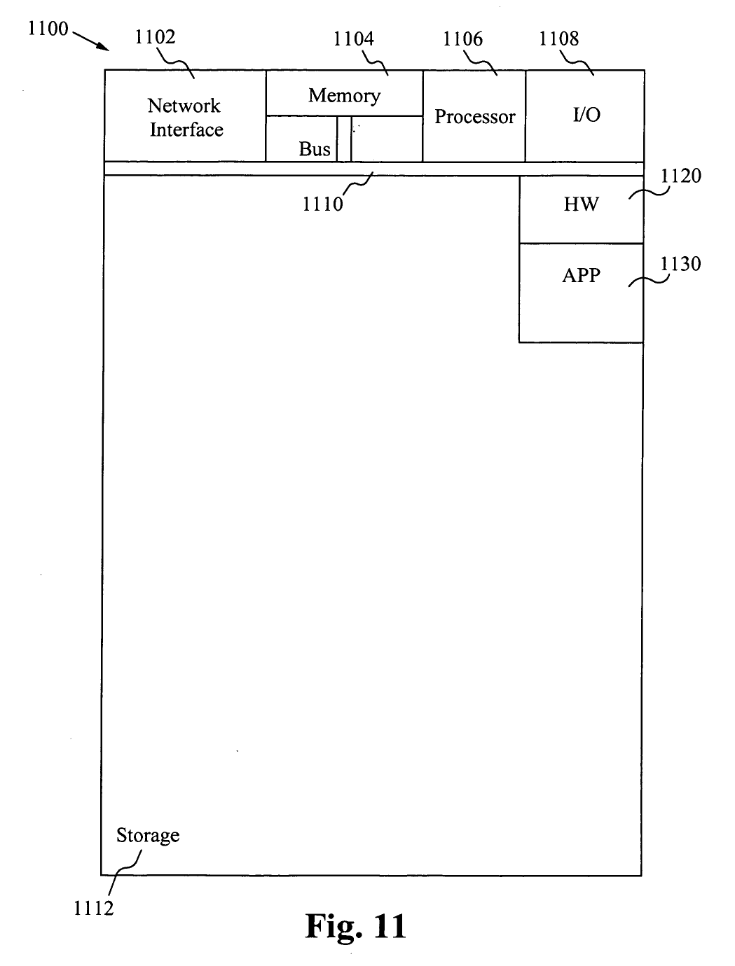

FIG. 11 illustrates a block diagram of an exemplary computing device 1100 configured to implement the method of extraction and reapplication of design information to existing websites. The computing device 1100 is able to be used to acquire, extract, store, compute, reapply, communicate and/or display information such as webpages. In general, a hardware structure suitable for implementing the computing device 1100 includes a network interface 1102, a memory 1104, a processor 1106, I/O device(s) 1108, a bus 1110 and a storage device 1112. The choice of processor is not critical as long as a suitable processor with sufficient speed is chosen. The memory 1104 is able to be any conventional computer memory known in the art. The storage device 1112 is able to include a hard drive, CDROM, CDRW, DVD, DVDRW, flash memory card or any other storage device. The computing device 1100 is able to include one or more network interfaces 1102. An example of a network interface includes a network card connected to an Ethernet or other type of LAN. The I/O device(s) 1108 are able to include one or more of the following: keyboard, mouse, monitor, display, printer, modem, touchscreen, button interface and other devices. Extraction and reapplication application(s) 1130 used to perform the method of extraction and reapplication are likely to be stored in the storage device 1112 and memory 1104 and processed as applications are typically processed. More or less components shown in FIG. 11 are able to be included in the computing device 1100. In some embodiments, extraction and reapplication hardware 1120 is included. Although the computing device 1100 in FIG. 11 includes applications 1130 and hardware 1120 for extraction and reapplication, the extraction and reapplication method is able to be implemented on a computing device in hardware, firmware, software or any combination thereof.

Examples of suitable computing devices include a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPod®, a video player, a DVD writer/player, a television, a home entertainment system or any other suitable computing device.

To utilize the method of and system for extraction and reapplication, a viewer/user is presented with an interface which presents a rendered web page to the viewer. An interactive element then enables the viewer to select elements. A second interface enables the viewer to specify how the selected elements relate to one or more template-regions of a design template. The selected elements are then replaced with programming code based upon the design template.

In operation, the method of and system for extraction and reapplication solves the problems of the prior art by enabling a non-technical user to generate a re-usable design template based off of an already existing website so that they are able to easily upgrade systems, add on new systems to their existing websites and/or migrate web content management platforms.

The present invention has been described in terms of specific embodiments incorporating details to facilitate the understanding of principles of construction and operation of the invention. Such reference herein to specific embodiments and details thereof is not intended to limit the scope of the claims appended hereto. It will be readily apparent to one skilled in the art that other various modifications may be made in the embodiment chosen for illustration without departing from the spirit and scope of the invention as defined by the claims.

What is claimed is:

1. A computer-implemented method of extracting a design template from a document comprising:
a. presenting a rendered page on a first interface to a viewer;
b. enabling the viewer to visually select elements from the rendered page using an interactive element;
c. enabling the viewer to specify how the selected elements relate to one or more template-regions of the design template using a second interface; and
d. replacing the selected elements with programming code as dictated by the design template.

2. The method of claim 1 wherein the rendered page is a rendered HTML page and the elements are HTML elements.

3. The method of claim 1 performed as a web service wherein:
a. a web server is configured to host a program performing the method and the web service is configured to obtain html by performing an http or https request to a second web server; and
b. a user interface of the program is a website.

4. The method of claim 1 wherein user information is associated with the design template.

5. The method of claim 1 wherein the interactive element is generated by drawing a visual queue around or on top of the selected element upon hovering over the selected element, and upon clicking, a visual indication of the selected elements is persisted.

6. The method of claim 1 further comprising generating an iconic representation of the design template as the viewer selects the template-regions of the design template by recording physical dimensions of the selected template-regions, recording total dimensions of the page and using the physical dimensions and the total dimensions to dynamically generate the iconic representation in proportion to the design template.

7. The method of claim 6 wherein the iconic representation of the design template takes the form of the rendered design template with graphical overlays to illustrate the template's regions.

8. The method of claim 6 wherein each template-region of the template-regions are visually differentiated in at least one of color, texture and animation based on a type of the template-region selected.

9. The method of claim 1 wherein the design template and the template-regions are pre-specified with preferential criteria for the elements required which guide actions of the interactive element to suggest or prevent selections of the elements.

10. The method of claim 1 wherein the design template utilizes a generic template definition which is defined using at least one of the criteria:
a. types of the template-regions required by the design template;
b. a number of the template-regions required of a certain type;
c. which of the elements act as a container for a template-region of the template regions;
d. which of the elements are contained in the template-region;
e. preferred elements for the template-region;
f. an explicit programming notation existing that indicates that a certain area in the page corresponds with a template-region definition; and
g. a model content for each of the template-regions for comparison.

11. The method of claim 10 wherein the elements are automatically selected based on matching at least one of the criteria.

12. The method of claim 1 wherein a selectable element includes a first repeated listing of similar elements that correspond with a second repeated listing of template-regions which are selected as a single aggregate template region.

13. The method of claim 1 further comprising proactively asking the viewer to select a specific template-region of the template in a sequential fashion.

14. The method of claim 1 wherein the viewer proactively selects which type of the template-region corresponds with the element the viewer is selecting.

15. A computer-implemented method of extracting Cascading Style Sheet (CSS) style information out of an existing page comprising:
a. presenting a rendered page on a first interface to a viewer;
b. enabling the viewer to visually select elements from the rendered page using an interactive element;
c. enabling the viewer to specify how the selected elements relate to one or more template-regions of a design template using a second interface;
d. replacing the selected elements with programming code as dictated by the design template;
e. storing previous contents of a selected template region of the one or more template-regions;
f. extracting the CSS style information from the selected elements;
g. storing the CSS style information applied to each selected element of a certain type in a template-region of the one or more template-regions; and
h. sorting the type of the template-region that contains the CSS style information obtained.

16. The method of claim 15 wherein the rendered page is a rendered HTML page and the elements are HTML elements.

17. The method of claim 15 wherein the CSS style information is distilled by finding a most common group of styles that are applied to a same type of element at a same time most frequently.

18. The method of claim 15 wherein the CSS style information from a specified type of the template-region is stored, while the CSS style information not from the specified type of the template-region is not stored.

19. The method of claim 15 wherein the CSS style information is collected for a parent element of the element to determine inherited styles.

20. A computer-implemented method of storing and retrieving design information comprising a repository of style information collected by:
a. presenting a rendered page on a first interface to a viewer;
b. enabling the viewer to visually select elements from the rendered page using an interactive element;
c. enabling the viewer to specify how the selected elements relate to one or more template-regions of a design template using a second interface;
d. replacing the selected elements with programming code as dictated by the design template;
e. storing previous contents of a selected template region of the one or more template-regions;
f. extracting the Cascading Style Sheet (CSS) style information from the selected elements;
g. storing the CSS style information applied to each selected element of a certain type in a template-region of the one or more template-regions; and
h. sorting the type of the template-region that contains the CSS style information obtained,
wherein the style information is programmatically accessible through an application programming interface.

21. The method of claim 20 wherein the rendered page is a rendered HTML page and the elements are HTML elements.

22. A computer-implemented method where an external application pulls essential design information as obtained by:
a. presenting a rendered page on a first interface to a viewer;
b. enabling the viewer to visually select elements from the rendered page using an interactive element;
c. enabling the viewer to specify how the selected elements relate to one or more template-regions of a design template using a second interface;
d. replacing the selected elements with programming code as dictated by the design template;
e. storing previous contents of a selected template region of the one or more template-regions;
f. extracting the Cascading Style Sheet (CSS) style information from the selected elements;
g. storing the CSS style information applied to each selected element of a certain type in a template-region of the one or more template-regions; and
h. sorting the type of the template-region that contains the CSS style information obtained,
thereby pulling the template and essential design information from a remote source.

23. The method of claim 22 wherein the rendered page is a rendered HTML page and the elements are HTML elements.

24. A computer-implemented method of manually merging an existing web page into a specific design template comprising:
a. presenting a rendered page to a viewer;
b. asking the viewer to choose a design template the page is merged into;
c. enabling the viewer to visually select elements using an interactive element;
d. enabling the viewer to specify how the selected element relates to a template-region of the design template using an interface; and
e. storing contents of the selected elements cross-referenced with the template-region each belongs to, a name of the page and a selected template.

25. The method of claim 24 wherein the rendered page is a rendered HTML page and the elements are HTML elements.

26. The method of claim 24 further comprising:
a. presenting the viewer with the visual icon of the template;
b. visually highlighting a specific template-region on the icon; and
c. requesting the viewer to choose the element on the page that corresponds with a visually highlighted element of the icon.

27. A computer-implemented method of automatically merging an existing web page into a specific design template comprising:
a. acquiring a document;
b. comparing the document with a plurality of templates to determine a closest match by detecting a presence of common XPaths in each;
c. identifying corresponding template-regions appearing in the document with the template-regions of a general design template as determined by corresponding XPath information, and template-definition criteria; and
d. storing contents of the selected elements cross-referenced with the template-regions each element contents belongs to, a name of the page and a selected template the page belongs to.

28. The method of claim 27 wherein the document is an HTML document and the plurality of templates are a plurality of HTML templates.

29. The method of claim 27 wherein the method switches to a manual merge when a failure to determine likeness to an existing template prompts the viewer with a request to perform one of manually selecting a matching template and generating a new template.

30. A computer-implemented system for extracting a design template from a document comprising:
a. a first interface configured for presenting a rendered page to a viewer;
b. an interactive element operatively coupled to the first interface, the interactive element configured for enabling the viewer to visually select elements from the rendered page;
c. a second interface operatively coupled to the interactive element, the second interface configured for enabling the viewer to specify how the selected elements relate to one or more template-regions of a design template; and
d. a display for presenting replacement of the selected elements with programming code as dictated by the design template.

31. The system of claim 30 wherein the rendered page is a rendered HTML page and the elements are HTML elements.

32. The system of claim 30 wherein the computer implemented system is selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPod®, a video player, a DVD writer/player, a television and a home entertainment system.

33. An apparatus comprising:
a. a memory for storing an application, the application configured for storing and retrieving design information comprising a repository of style information collected by:
i. presenting a rendered page on a first interface to a viewer;
ii. enabling the viewer to visually select elements from the rendered page using an interactive element;
iii. enabling the viewer to specify how the selected elements relate to one or more template-regions of a design template using a second interface;
iv. replacing the selected elements with programming code as dictated by the design template;
v. storing previous contents of a selected template region of the one or more template-regions;
vi. extracting the Cascading Style Sheet (CSS) style information from the selected elements;
vii. storing the CSS style information applied to each selected element of a certain type in a template-region of the one or more template-regions; and
viii. sorting the type of the template-region that contains the CSS style information obtained,
wherein the style information is programmatically accessible through an application programming interface; and
b. a processing component coupled to the memory, the processing component configured for processing the application.

34. The apparatus of claim 33 wherein the rendered page is a rendered HTML page and the elements are HTML elements.

35. The apparatus of claim 33 wherein the apparatus is selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPod®, a video player, a DVD writer/player, a television and a home entertainment system.
